(19) United States
(12) Patent Application Publication
(10) Pub. No.: US 2026/0104982 A1
(43) Pub. Date: Apr. 16, 2026

(54) BLUEPRINT VALIDATION FRAMEWORK

(71) Applicant: Dell Products L.P., Round Rock, TX (US)

(72) Inventors: NETANEL SHALOM, Ra’anana (IL); MAXIM BALIN, Gan-Yavne (IL); ELIYAHU ROSENES, Bet Shemesh (IL)

(21) Appl. No.: 18/911,875

(22) Filed: Oct. 10, 2024

(51) Int. Cl. G06F 11/36; G06F 21/53

(52) U.S. Cl. CPC G06F 11/3624; G06F 11/366; G06F 21/53

(57) ABSTRACT

Methods and systems for managing operation of a deployment are disclosed. The operation may be managed by verifying operation of a data processing system of the deployment. The operation may be verified by validating a configuration of a blueprint on which the operation of the data processing system is based. The configuration of the blueprint may be validated by performing testing on the configuration of the blueprint. The testing may include a syntactical analysis, adding at least one checkpoint on at least one line of the blueprint, a sandboxed operation using the blueprint to screen for at least one inefficiency and/or at least one anomalous behavior, securing the blueprint with at least one authentication method, and/or tracking at least one change to the blueprint.

### FIELD

Embodiments disclosed herein relate generally to managing operation of a deployment. More particularly, embodiments disclosed herein relate to blueprint based management for the deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIG. 3A-3D show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting.

Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment. The operation may be managed by verifying operation of a data processing system. The operation may be verified by validating a configuration of a blueprint that is used to update the operation of the data processing system. The configuration of the blueprint may be validated by performing testing of the blueprint using a blueprint validation framework.

The blueprint validation framework may include (i) a syntactical analysis of the configuration of the blueprint to ensure use of at least one markup language in the blueprint, (ii) addition of at least one checkpoint to verify operation at least one line and/or portion of the blueprint, (iii) a sandboxed operation using the configuration of the blueprint in a virtual machine, container, and/or dedicated testing environment that includes monitoring for at least one inefficiency in the performance of the sandboxed operation, (iv) continuation of the sandboxed operation that also includes checking for at least one anomalous behavior in the sandboxed operation, (v) securing of the blueprint using at least one authentication method, and (iv) tracking changes to the blueprint, the tracking of the changes also including reverting to a previous version of the blueprint.

The blueprint validation framework may generate a validated blueprint. The configuration of the data processing system may be updated to match the configuration of the validated blueprint. As a result, the data processing system may perform a verified operation and may be used to provide desirable computer implemented services.

In an embodiment, a method for managing operation of a deployment is disclosed. The method may include (i) identifying an occurrence of a blueprint use event with respect to a data processing system of the deployment, (ii) based on the occurrence of the blueprint use event: (a) obtaining a blueprint, the blueprint being a validated blueprint based on both syntactic analysis and sandboxed operation, and the blueprint comprising checkpoints usable to improve a likelihood of successful updating of the data processing system using the blueprint and control data to limit use of the blueprint, (b) updating the data processing system using the blueprint to obtain an updated data processing system, and (c) providing computer implemented services using at least the updated data processing system.

Obtaining the blueprint may include receiving from an administrator or a repository of blueprints and based on the blueprint use event, the blueprint.

Updating the data processing system using the blueprint may include performing, using the blueprint, at least one update to place the data processing system in a verified operating state while the computer implemented services are provided.

The method may further include, prior to identifying the occurrence of the blueprint use event: (i) obtaining a prototype blueprint for use with data processing systems of the deployment, (ii) syntactically analyzing the prototype blueprint to identify syntactic errors in markup language of the prototype blueprint, (iii) in a first instance of the syntactically analyzing where at least one syntactic error is identified: modifying the prototype blueprint to remove the at least one syntactic error to obtain a syntactically correct prototype blueprint, (iv) in a second instance of the syntactically analyzing where no syntactic errors are identified: concluding that the prototype blueprint is the syntactically correct prototype blueprint.

Syntactically analyzing the prototype blueprint to identify the syntactic errors may include checking a configuration of the prototype blueprint against at least one rule in a markup language used to write the configuration to ensure that the configuration of the prototype blueprint has correct syntax.

The method may further include, prior to identifying the occurrence of the blueprint use event and after syntactically analyzing the prototype blueprint: (i) obtaining, using the syntactically correct prototype blueprint, an interrupt-driven syntactically correct blueprint by adding the checkpoints in the interrupt-driven syntactically correct blueprint to track operation of the data processing system, (ii) performing, using the interrupt-driven syntactically correct blueprint, monitoring of the sandboxed operation for an inefficient performance of the data processing system, (iii) in the first instance of the monitoring where a metric, from the sandboxed operation, is obtained that indicates the inefficient performance of the data processing system: modifying the interrupt-driven syntactically correct blueprint to improve the inefficient performance of the interrupt-driven syntactically correct blueprint to obtain an optimized interrupt-driven syntactically correct blueprint, and (iv) in the second instance of the monitoring where the metric, from the sandboxed operation, is obtained that does not indicate the inefficient performance of the data processing system: concluding that the interrupt-driven syntactically correct blueprint is the optimized interrupt-driven syntactically correct blueprint.

Performing the monitoring of the sandboxed operation may include (i) simulating, using the interrupt-driven syntactically correct blueprint, the operation of the data processing system in an isolated environment apart of the deployment and (ii) obtaining, based on the simulating of the operation of the data processing system, the metric that indicates the inefficient performance of the data processing system.

The method may further include, prior to identifying the occurrence of the blueprint use event and after monitoring of the sandboxed operation for the inefficient performance of the data processing system: (i) performing, using the optimized interrupt-driven syntactically correct blueprint, an anomalous behavior analysis of the sandboxed operation of the data processing system, (ii) in the first instance of the performing where at least one anomalous behavior has been found in the sandboxed operation: modifying the optimized interrupt-driven syntactically correct blueprint to remove the at least one anomalous behavior of the optimized interrupt-driven syntactically correct blueprint to obtain an anomaly-free optimized interrupt-driven syntactically correct blueprint, (iii) in the second instance of the performing where at least one anomalous behavior has not been found in the operation: concluding that the optimized interrupt-driven syntactically correct blueprint is the anomaly-free optimized interrupt-driven syntactically correct blueprint, and (iv) securing the anomaly-free optimized interrupt-driven syntactically correct blueprint using at least one authentication method to obtain the blueprint.

Performing the anomalous behavior analysis may include (i) simulating, using the optimized interrupt-driven syntactically correct blueprint, the operation of the data processing system and (ii) screening the simulating of the operation of the data processing system using at least one machine learning method for at least one anomalous behavior, the anomalous behavior being an unexpected behavior or at least one deviation from an expected behavior.

The at least one authentication method may be used protect the blueprint from unauthorized use by assigning an authorized user of the blueprint at least a private key for encryption of the blueprint and at least a public key for decryption of the blueprint.

Securing the anomaly-free optimized interrupt-driven syntactically correct blueprint using the at least one authentication method may include (i) tracking at least one change to the blueprint and (ii) permitting reverting of the at least one change to the blueprint.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

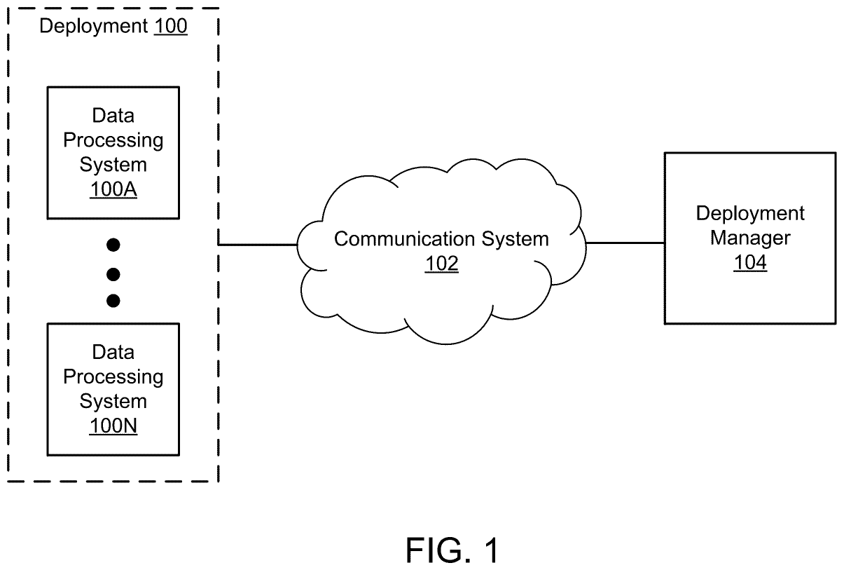

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, an operation of a data processing system may be updated based on a new configuration of a blueprint. The operation may be updated by (i) reading the blueprint to obtain the new configuration for the operation the data processing system, (ii) comparing a current configuration of the operation of the data processing system to the new configuration, and (iii) applying changes to the current configuration so that the operation of the data processing system is based on the new configuration.

However, before updating the operation of the data processing system, the new configuration may need to be verified for correct functionality and operational behavior. If the new configuration is not tested, then, upon utilization of the new configuration, operation of the data processing system may face several issues such as (i) system instability (e.g., system unresponsiveness, unpredictable behavior, etc.), (ii) data loss and/or corruption, (iii) security vulnerabilities (e.g., increased susceptibility to malicious behavior), (iv) performance degradation (e.g., slower processing times, inefficient resource utilization, etc.), etc.

In general, embodiments disclosed here relate to systems and methods for managing operation of a deployment. The operation may be managed by verifying the operation of a data processing system of the deployment. To verify the operation of the data processing system, a blueprint used in the operation of the data processing system may be validated.

To validate the blueprint, a syntactical analysis of a markup language of the configuration of a prototype blueprint may be performed. The prototype blueprint may be a preliminary version of the blueprint. The prototype blueprint may be obtained after creation of the prototype blueprint from an administrator and/or a repository of blueprints. During the syntactical analysis, at least one syntactic error in the configuration may be screened and corrected to generate a syntactically correct prototype blueprint.

To the configuration of the syntactically correct prototype blueprint, at least one checkpoint may be added to generate an interrupt-driven syntactically correct prototype blueprint. The at least one checkpoint may be used to track the operation of the data processing system.

With the configuration of the interrupt-driven syntactically correct prototype blueprint, a sandboxed operation of the data processing system may be performed. The sandboxed operation may include performance of the data processing system, for example, in an isolated environment apart from the deployment, such as a deployment manager. The sandboxed operation may be performed to obtain at least one metric indicating an inefficient performance of the data processing system. Based on the at least one metric, the configuration of the interrupt-driven syntactically correct prototype blueprint may be modified to generate an optimized interrupt-driven syntactically correct prototype blueprint.

The sandboxed operation of the data processing system may be performed using the optimized interrupt-driven syntactically correct prototype blueprint. During the sandboxed operation, an anomalous behavior analysis may be performed. During the anomalous behavior analysis, the sandboxed operation may be screened using at least one machine learning method to monitor for at least one anomalous behavior. The at least one anomalous behavior may include an unexpected behavior and/or at least one deviation from an expected behavior. Based on the at least one anomalous behavior that has been found, the configuration of the optimized interrupt-driven syntactically correct prototype blueprint may be modified to remove the at least one anomalous behavior to generate an anomaly-free optimized interrupt-driven syntactically correct prototype blueprint.

Finally, the anomaly-free optimized interrupt-driven syntactically correct prototype blueprint may be secured to generate the blueprint. The anomaly-free optimized interrupt-driven syntactically correct prototype blueprint may be secured by safeguarding the anomaly-free optimized interrupt-driven syntactically correct prototype blueprint using at least one authentication method. The at least one authentication method may include generation of a public key and/or a private key for at least one authorized user of the blueprint to encrypt and/or decrypt, respectively, the blueprint. Safeguarding the anomaly-free optimized interrupt-driven syntactically correct prototype blueprint may include tracking at least one change to the blueprint and/or permitting reverting of the at least one change to the blueprint.

Deployment manager 104 may use the interrupt-driven syntactically correct prototype blueprint to perform a sandboxed operation of the data processing system.

To provide the above noted functionality, the system may include deployment 100, and deployment manager 104. Each of these components is discussed below.

Deployment 100 may include any number of data processing system 100A-100N. At least one of the any number of data processing system 100A-100N may perform an operation. The operation may be used to provide at least one computer implemented service. The operation may be performed based on a configuration of a blueprint. The configuration of the blueprint may have been validated by deployment manager 104. Upon validation of the configuration of the blueprint, a previous configuration of at least one of any number of data processing system 100A-100N may be updated based on the configuration of the blueprint. Deployment manager 104 may perform the validation of the configuration of the blueprint. To perform the validation, a prototype blueprint may be obtained. The prototype blueprint may be a preliminary version of the blueprint. The prototype blueprint may be obtained after creation of the prototype blueprint from an administrator and/or a repository of blueprints. Using the prototype blueprint, a syntactical analysis of a markup language of a configuration of the prototype blueprint may be performed to correct syntactical errors in the prototype blueprint. Deployment manager 104 may generate, from correction of the syntactical errors, a syntactically correct prototype blueprint. Deployment manager 104 may add at least checkpoint to the syntactically correct prototype blueprint. From the addition of the at least one checkpoint, an interrupt-driven syntactically correct prototype blueprint may be generated. The at least one checkpoint may be used to track the operation of the data processing system.

Deployment manager 104 may perform a sandboxed operation with the interrupt-driven syntactically correct prototype blueprint. The sandboxed operation may be performed to obtain at least one metric indicating an inefficient performance of the data processing system. Based on the at least one metric, deployment manager 104 may modify the interrupt-driven syntactically correct prototype blueprint to generate an optimized interrupt-driven syntactically correct prototype blueprint.

Deployment manager 104 may perform the sandboxed operation of the data processing system using the optimized interrupt-driven syntactically correct prototype blueprint. During the sandboxed operation, deployment manager 104 may perform an anomalous behavior analysis. During the anomalous behavior analysis, deployment manager 104 may screen the sandboxed operation for using at least one machine learning method for at least one anomalous behavior. The at least one anomalous behavior may include an unexpected behavior and/or at least one deviation from an expected behavior. Based on the at least one anomalous behavior has been found, deployment manager 104 may correct the configuration of the optimized interrupt-driven syntactically correct prototype blueprint to remove the at least one anomalous behavior to generate an anomaly-free optimized interrupt-driven syntactically correct prototype blueprint.

Finally, deployment manager 104 may secure the anomaly-free optimized interrupt-driven syntactically correct prototype blueprint to generate the blueprint. Deployment manager 104 may secure the anomaly-free optimized interrupt-driven syntactically correct prototype blueprint by safeguarding the anomaly-free optimized interrupt-driven syntactically correct prototype blueprint using at least one authentication method. The at least one authentication method may include generation of a public key and/or a private key for at least one authorized user to encrypt and/or decrypt, respectively, the blueprint. Safeguarding, by deployment manager 104, the anomaly-free optimized interrupt-driven syntactically correct prototype blueprint may include tracking at least one change to the blueprint and/or permitting reverting of the at least one change to the blueprint.

Deployment manager 104 may, after validating the configuration of the blueprint, update operation of at least one of the any number of data processing systems (e.g., 100A-100N). The operation may be updated by (i) reading the configuration of the blueprint, (ii) comparing a current configuration of the data processing system to the configuration of the blueprint, and (iii) applying changes to the current configuration so that the operation of the data processing system is based on the configuration of the blueprint.

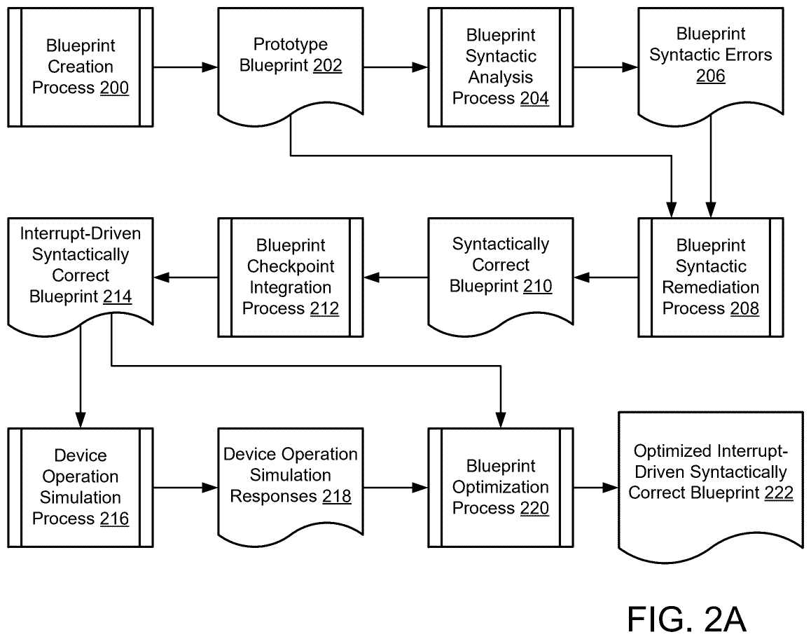

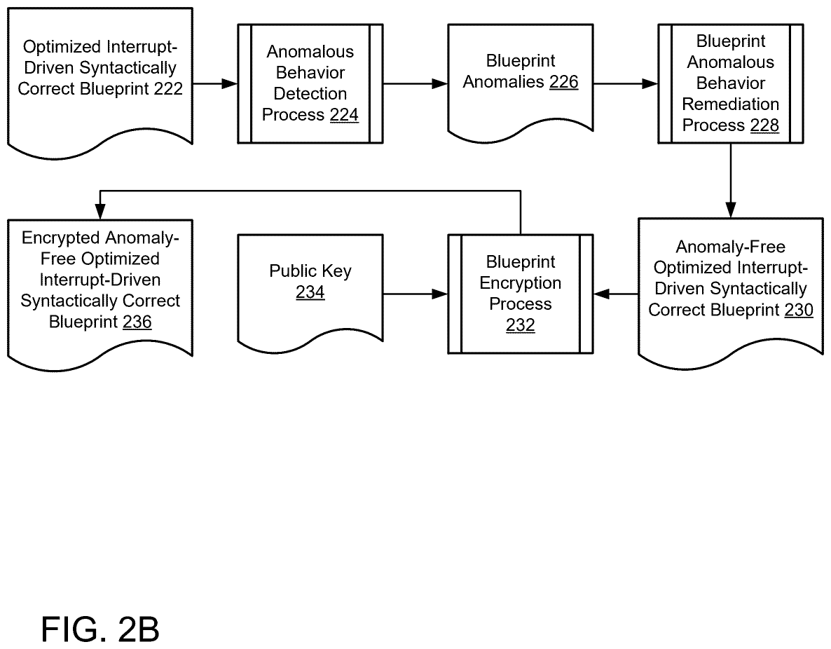

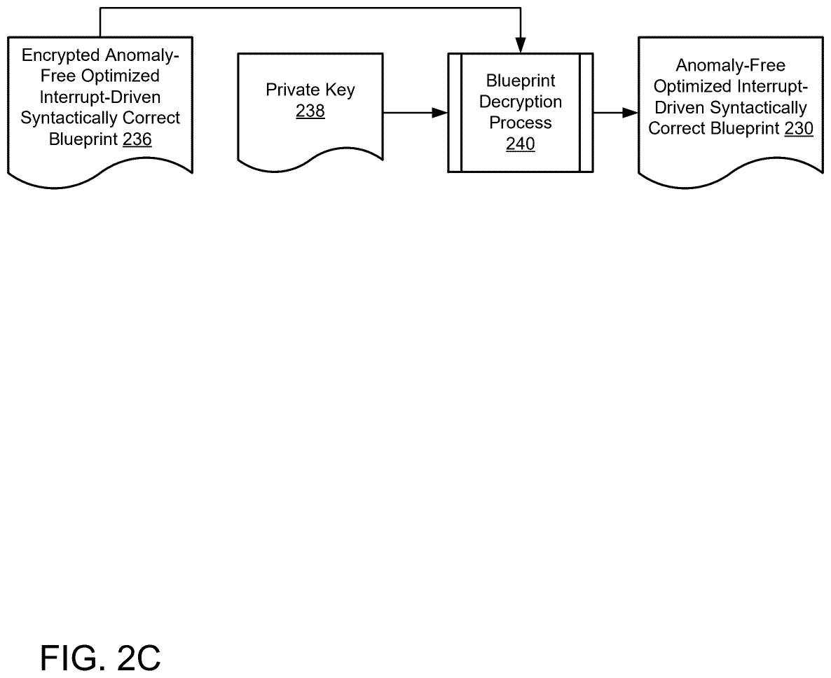

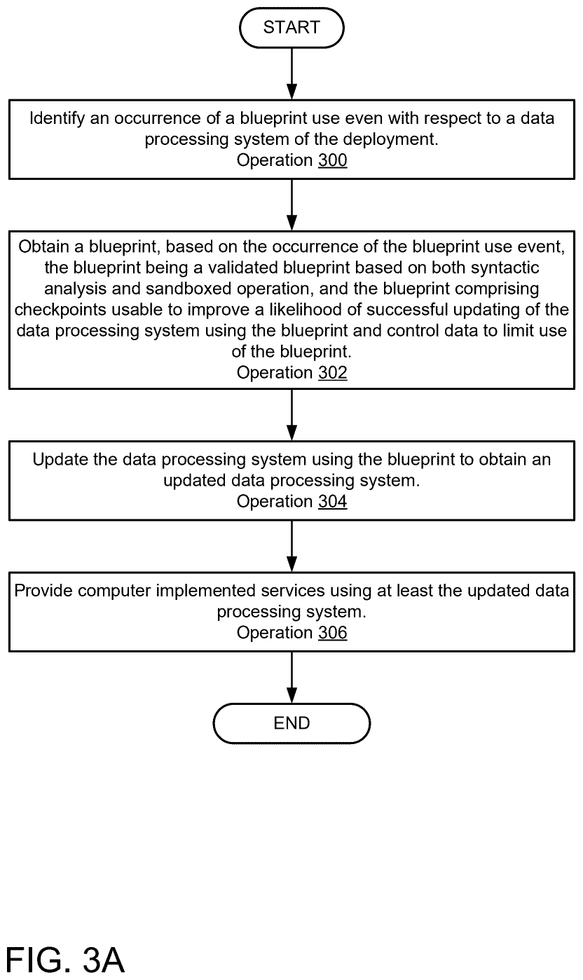

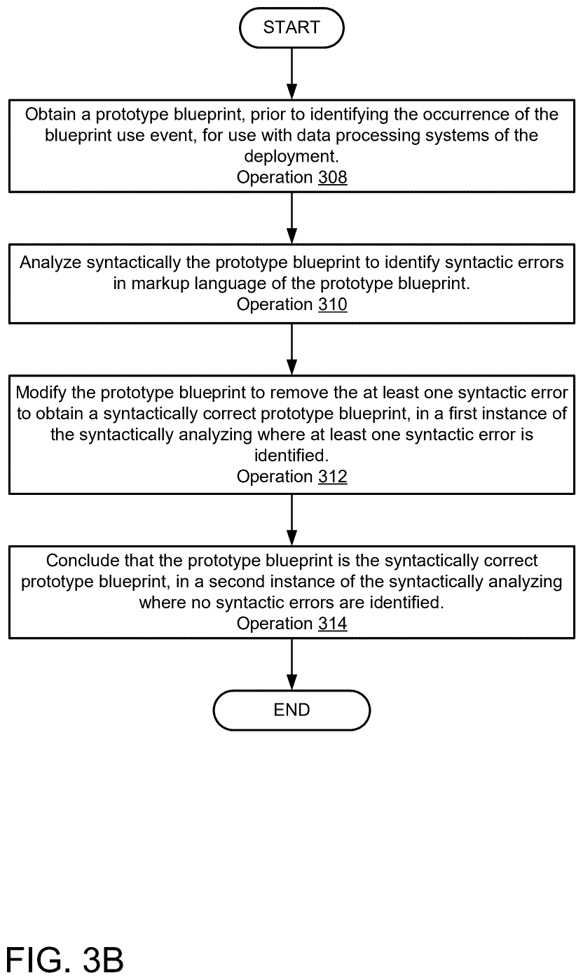

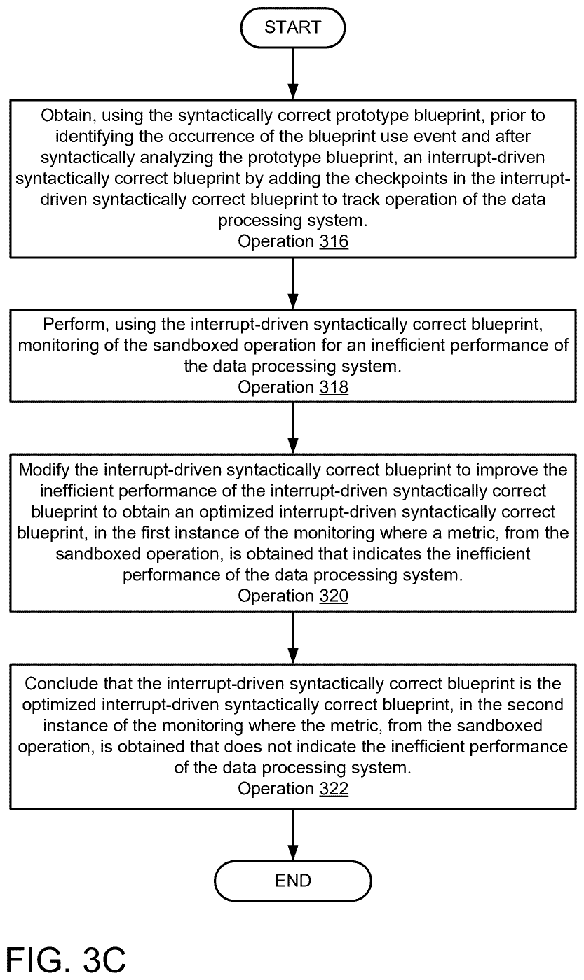

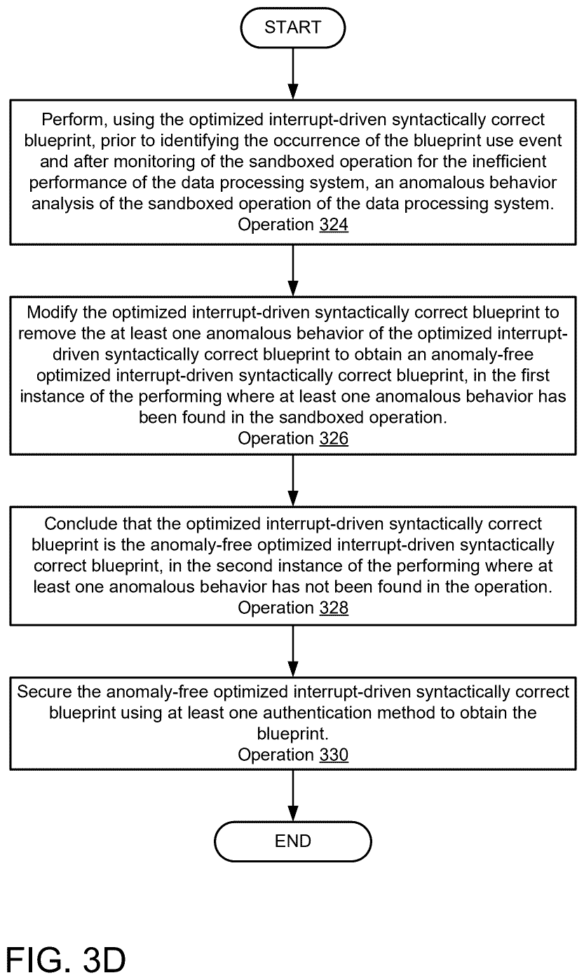

While providing their functionality, any of deployment 100 and deployment manager 104 may perform all, or a portion, of the flows and methods shown in FIGS. 2A-3D.

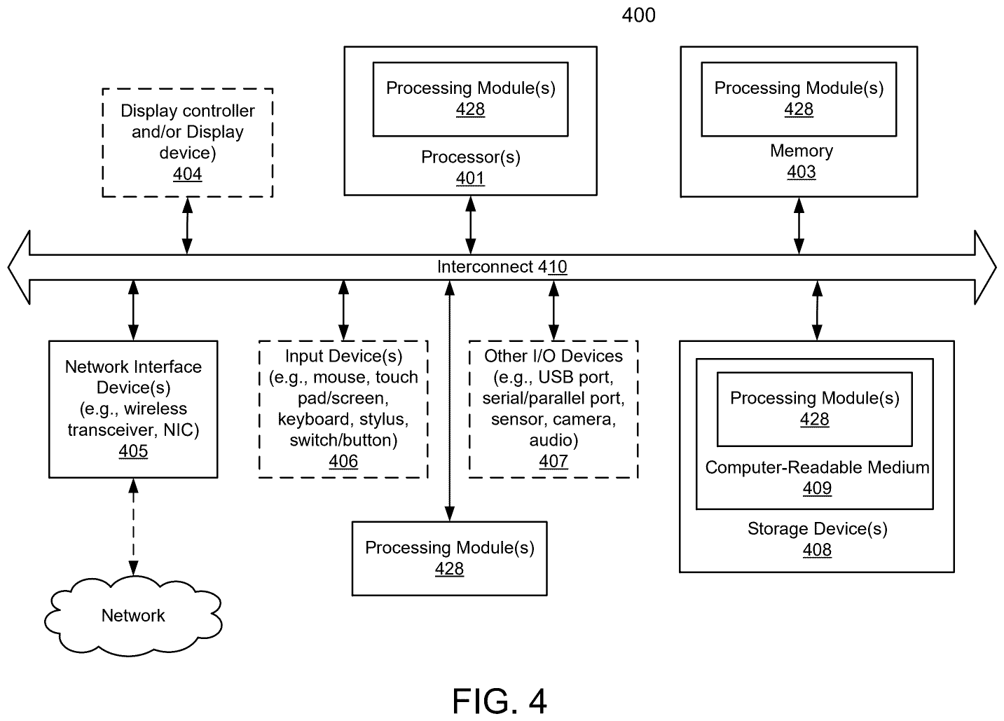

Any of (and/or components thereof) deployment 100 and deployment manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 202, 206, etc.) is used to represent data structures and a second set of shapes (e.g., 200, 204, etc.) is used to represent processes performed using and/or that generate data.

Turning to FIG. 2A, a first data flow diagram in accordance with an embodiment is shown. The first data flow diagram may illustrate data used in and data processing performed in generating an optimized interrupt-driven syntactically correct blueprint.

To generate the optimized interrupt-driven syntactically correct blueprint, blueprint creation process 200 may be performed. During blueprint creation process 200, a configuration of a blueprint for a data processing system (e.g., 100A, 100B, etc.) may be designed. The configuration may include an arrangement of components and/or parameters that define how the data processing system operates. The components may include hardware and/or software, the parameters may include network settings and/or data flows.

To design the configuration, a scope of the data processing system may be defined. The scope may include processes, data inputs and/or outputs, and/or desired outcomes. Also, an architecture of the data processing system may be defined. The architecture may include programming languages, frameworks, etc. The architecture may further be defined based on (i) application programming interfaces for communication between components, (ii) databases and the types of data stored in the databases, (iii) security measures for authentication, encryption, and/or security protocols, etc.

Finally, details of the configuration and the components of the architecture may be documented. The documentation may include setup procedures, system operating procedures, troubleshooting procedures, etc. The configuration and the documentation may be included in prototype blueprint 202.

Prototype blueprint 202 may include a preliminary version of the configuration generated during blueprint creation process 200. The configuration may be untested and have at least one design flaw. The at least one design flaw may be identified and corrected before updating operation of a data processing system based on the configuration.

To test prototype blueprint 202, blueprint syntactic analysis process 204 may be performed. During blueprint syntactic analysis process 204, a syntactical analysis of a markup language used in prototype blueprint 202 may be performed. The syntactic analysis may screen for syntactic errors in the use of the markup language in the configuration of prototype blueprint 202. The syntactic errors may include (i) improper use of keywords, operators, and/or symbols, (ii) incorrect structure of loops, conditionals, etc., (iii) invalid identifiers (e.g., incorrect use of variables, functions, etc.), (iv) incorrectly structured function calls, etc.

Blueprint syntactic errors 206 may be obtained as a result of the syntactic analysis. Blueprint syntactic errors 206 may include an organization of syntactic errors by locations such as, for example, line number and/or character number on the line number of a blueprint file and/or blueprint page. The syntactic errors may be categorized by (i) missing and/or mismatched delimiters (e.g., omission of a parenthesis in an expression), (ii) incorrect and/or missing keywords, (iii) invalid statements (e.g., inclusion of a character that renders a line as invalid), (iv) misuse of operators (e.g., inclusion of a ‘+’ where a ‘=’ is needed), etc.

To remediate prototype blueprint 202, blueprint syntactic remediation process 208 may be performed. During blueprint syntactic remediation process 208, blueprint syntactic errors 206 may be ingested with prototype blueprint 202. Following the ingestion, a syntactic error of the syntactic errors may be reviewed. Review of the syntactic error may include using a location of the syntactic error to identify the syntactic error in prototype blueprint 202. Once the syntactic error has been found in prototype blueprint 202, a correction for the syntactic error may be determined. The correction may be determined by screening a portion of configuration around the location of the syntactic error. The screening may be used to determine a context of the configuration around the location of the syntactic error. Once the context has been determined, the correction may be determined by applying a modification to the configuration that aligns with the context.

Corrections for the syntactic errors in prototype blueprint 202 may be used to generate syntactically correct blueprint 210. Syntactically correct blueprint 210 may include the configuration that complies with rules of the markup language used in the configuration. As syntactically correct blueprint 210 complies with the rules of the markup language, blueprint checkpoint integration process 212 may be performed.

During blueprint checkpoint integration process 212, at least one validation step may be included in syntactically correct blueprint 210. At the at least one validation step in syntactically correct blueprint 210, at least one check may be performed to ensure that the configuration operates correctly at a line and/or portion of the configuration. For example, during operation by a data processing system (e.g., 100A, 100B, etc.) using the configuration of syntactically correct blueprint 210, a checkpoint may perform a check to validate that data is passed properly to at least one line of the configuration. A checkpoint may also be used to verify that, for example, (i) a variable is properly declared in a line of the configuration, (ii) data is correctly processed in the line of the configuration, etc.

Interrupt-driven syntactically correct blueprint 214 may be generated during blueprint checkpoint integration process 212. Interrupt-driven syntactically correct blueprint 214 may include at least one checkpoint that validates functionality of the configuration of interrupt-driven syntactically correct blueprint 214 during operation of a data processing system. When a checkpoint is reached in the configuration, the configuration may respond, for example, with an error notification during the operation if an error occurs in the functionality of the configuration. Otherwise, when the checkpoint is reached in the configuration, if the error does not occur in the functionality of the configuration, the operation may proceed without the error notification.

Interrupt-driven syntactically correct blueprint 214 may be ingested by device operation simulation process 216. During device operation simulation process 216, the configuration of interrupt-driven syntactically correct blueprint 214 may be ingested by a sandboxed environment. The sandboxed environment may include a virtual machine, container, and/or dedicated testing environment hosted by a deployment manager (e.g., 104). Any components, services, and/or dependencies of interrupt-driven syntactically correct blueprint 214 may be included in the sandboxed environment.

Using the sandboxed environment, testing may be performed using the configuration of interrupt-driven syntactically correct blueprint 214. The testing may validate that features of the configuration are performing as expected. The testing may also generate at least one performance metric, such as resource usage and response times, to ensure that desired performance criteria are met.

At least one response from the sandboxed operation may be obtained during device operation simulation responses 218. The at least one response may include at least one inefficiency from the at least one performance metric. The at least one inefficiency may include (i) suboptimal resource allocation of memory, computer processing units (CPU), and/or storage resources, (ii) inefficient data retrieval and/or processing, (iii) inadequate scaling for increased loads, (iv) unoptimized code of the configuration that leads to slow performance and/or high resource consumption, etc.

To improve an efficiency of the configuration of interrupt-driven syntactically correct blueprint 214, blueprint optimization process 220 may be performed. During blueprint optimization process 220, at least one modification to interrupt-driven syntactically correct blueprint 214 may be performed. The at least one modification may include (i) adjusting CPU, memory, and/or storage resource limits, (ii) introducing and/or refining indexing strategies to increase a rate of query performance, (iii) refactoring the unoptimized code to generate more efficient algorithms of the configuration, (iv) introducing load balancing mechanisms to scale loads, etc.

During blueprint optimization process 220, optimized interrupt-driven syntactically correct blueprint 222 may be generated. Optimized interrupt-driven syntactically correct blueprint 222 may yield an increased efficiency in the operation, compared to the operation based on interrupt-driven syntactically correct blueprint 214. The increased efficiency may be due to the at least one modification made based on device operation simulation responses 218 to yield an improved performance and/or enhanced resource utilization.

Thus, via the data flow illustrated in FIG. 2A, a system in accordance with an embodiment may generate an optimized interrupt-driven syntactically correct blueprint. Consequently, a deployment (e.g., 100) may be more likely to be able to provide desired computer implemented services by performing an operation based on the configuration of a blueprint with which (i) syntactic errors have been removed, (ii) checkpoints are used to validate operation in at least one portion of the configuration, and/or (iii) an efficiency of a sandboxed operation of the configuration has been enhanced.

Turning to FIG. 2B, a first data flow diagram in accordance with an embodiment is shown. The first interaction diagram may illustrate data used in and data processing performed in generating an encrypted anomaly-free optimized interrupt-driven syntactically correct blueprint.

To generate the encrypted anomaly-free optimized interrupt-driven syntactically correct blueprint, anomalous behavior detection process 224 may be performed. During anomalous behavior detection process 224, an anomalous behavior analysis may be performed in the sandboxed operation that is based on optimized interrupt-driven syntactically correct blueprint 222. To perform the anomalous behavior analysis, optimized interrupt-driven syntactically correct blueprint 222 may be ingested by the sandboxed environment used in the description of FIG. 2A. The sandboxed environment may include a virtual machine, container, and/or dedicated testing environment hosted by a deployment manager (e.g., 104). Any components, services, and/or dependencies may be included in the sandboxed environment.

A machine learning model may be selected to observe a behavior of the operation that takes place in the sandboxed environment. The machine learning model may include a supervised learning model, an unsupervised learning model, and/or a semi-supervised learning model. The machine learning model may be trained using data obtained from the operation of a configuration of a blueprint similar to optimized interrupt-driven syntactically correct blueprint 222.

New data may be gathered from the operation based on the configuration of optimized interrupt-driven syntactically correct blueprint 222. The new data may be compared to the data and blueprint anomalies 226 may be obtained from the comparison. Blueprint anomalies 226 may include (i) incorrect parameter values (e.g., memory allocations, thread limits, buffer sizes for input/output operations, log retention limits that lead to a loss of historical observations in the operation), (ii) security vulnerabilities (open ports, weak encryption settings, missing configurations for authentication mechanisms), (iii) conflicting rules in policies that regulate data processing that lead to incorrect handling of the data, etc.

To remediate the sandboxed operation, blueprint anomalous behavior remediation process 228 may be performed. During blueprint anomalous behavior remediation process 228, at least one modification may be made to the configuration of optimized interrupt-driven syntactically correct blueprint 222. The at least one modification may include (i) adjusting parameter values (e.g., establishing desired memory allocation limits, desired thread limits, desired log retention timelines, etc.), (ii) including new security protocols (e.g., opening and closing ports, setting encryption parameters, establishing authentication mechanisms), (iii) defining new policies that regulate data processing for different types of data, etc. As a result, from optimized interrupt-driven syntactically correct blueprint 222, anomaly-free optimized interrupt-driven syntactically correct blueprint 230 may be generated.

To secure anomaly-free optimized interrupt-driven syntactically correct blueprint 230, blueprint encryption process 232 may be performed. During blueprint encryption process 232, a public key/private key pair may be generated for an authorized user of anomaly-free optimized interrupt-driven syntactically correct blueprint 230. The authorized user may encrypt anomaly-free optimized interrupt-driven syntactically correct blueprint 230 using public key 234. As a result, encrypted anomaly-free optimized interrupt-driven syntactically correct blueprint 236 may be generated. Encrypted anomaly-free optimized interrupt-driven syntactically correct blueprint 236 may include ciphertext of anomaly-free optimized interrupt-driven syntactically correct blueprint 230. Blueprint encryption process 232 may include tracking at least one change and/or permitting reverting of the at least one change to encrypted anomaly-free optimized interrupt-driven syntactically correct blueprint 236.

Thus, via the data flow illustrated in FIG. 2B, a system in accordance with an embodiment may generate the encrypted anomaly-free optimized interrupt-driven syntactically correct blueprint. Consequently, a deployment (e.g., 100) may be more likely to be able to provide desired computer implemented services by (i) enhancing a performance of an operation of a data processing system that uses a configuration of encrypted anomaly-free optimized interrupt-driven syntactically correct blueprint and (ii) securing use of the encrypted anomaly-free optimized interrupt-driven syntactically correct blueprint to be limited to an authorized user.

Turning to FIG. 2C, a third data flow diagram in accordance with an embodiment is shown. The first interaction diagram may illustrate data used in and data processing performed in decrypting an encrypted anomaly-free optimized interrupt-driven syntactically correct blueprint.

To decrypt the encrypted anomaly-free optimized interrupt-driven syntactically correct blueprint, blueprint decryption process 240 may be performed. During blueprint decryption process 240, encrypted anomaly-free optimized interrupt-driven syntactically correct blueprint 236 may be decrypted to obtain anomaly-free optimized interrupt-driven syntactically correct blueprint 230. Encrypted anomaly-free optimized interrupt-driven syntactically correct blueprint 236 may be decrypted by converting a ciphertext of encrypted anomaly-free optimized interrupt-driven syntactically correct blueprint 236 into a plaintext of anomaly-free optimized interrupt-driven syntactically correct blueprint 230. During blueprint decryption process 240, private key 238 from an authorized user may be used to convert the ciphertext to the plaintext. As a result, anomaly-free optimized interrupt-driven syntactically correct blueprint 230 may be obtained.

Thus, via the data flow illustrated in FIG. 2B, a system in accordance with an embodiment may decrypt the encrypted anomaly-free optimized interrupt-driven syntactically correct blueprint. Consequently, a deployment (e.g., 100) may be more likely to be able to provide desired computer implemented services by obtaining, by an authorized user with a private key, the encrypted anomaly-free optimized interrupt-driven syntactically correct blueprint.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location. As discussed above, the components of FIG. 1 may perform various methods to manage data processing systems. FIG. 3A illustrates a method that may be performed by the components of the system of FIG. 1. In the diagram discussed below and shown in FIG. 3A, any of the operations may be repeated, performed in different orders, and/or performed in parallel with or in a partially overlapping in time manner with other operations.

Turning to FIG. 3A, a flow diagram illustrating a method of managing operation of a deployment in accordance with an embodiment is shown. The method may be performed, for example, by any of the components of the system of FIG. 1, and/or other components not shown therein.

At operation 300, an occurrence of a blueprint use event may be identified with respect to a data processing system of the deployment. The occurrence may be identified by performing a notification for an update to an operation of the data processing system. The notification may be performed by an administrator, the data processing system, and/or a deployment manager (e.g., 104).

At operation 302, a blueprint may be obtained, based on the occurrence of the blueprint use event, the blueprint being a validated blueprint based on both syntactic analysis and sandboxed operation, and the blueprint comprising checkpoints usable to improve a likelihood of successful updating of the data processing system using the blueprint and control data to limit use of the blueprint. The blueprint may be obtained by receiving from the administrator and/or a repository of blueprints and based on the blueprint use event, the blueprint. The blueprint may be received by sending, by the administrator and/or an automated service of the repository of the blueprints, the blueprint using a communication system (e.g., 102).

At operation 304, the data processing system may be updated using the blueprint to obtain an updated data processing system. The data processing system may be updated by performing, using the blueprint, at least one update to place the data processing system in a verified operating state while the computer implemented services are provided. The at least one update may be performed by modifying a configuration of the data processing system to match the configuration of the blueprint. At operation 306, computer implemented services may be provided using at least the updated data processing system. The computer implemented services may be provided performing, by the updated data processing system, an operation based on a configuration of the blueprint.

The method may end following operation 306.

Thus, via the method shown in FIG. 3A, embodiments herein may likely improve a likelihood of managing the operation of the deployment. By improving the likelihood of managing the operation of the deployment, the data processing systems may be more likely to provide desirable computer implemented services by, for example, updating the operation of data processing system based on the configuration of the blueprint, the blueprint being a validated blueprint, providing desirable computer implemented services through a verified operation of the data processing system, etc.

Turning to FIG. 3B, a second flow diagram illustrating the method of managing operation of a deployment in accordance with an embodiment is shown. The method may be performed, for example, by any of the components of the system of FIG. 1, and/or other components not shown therein.

At operation 308, a prototype blueprint may be obtained, prior to identifying the occurrence of the blueprint use event, for use with data processing systems of the deployment. The prototype blueprint may be obtained by receiving the prototype blueprint from a blueprint creation process.

At operation 310, the prototype blueprint may be syntactically analyzed to identify syntactic errors in markup language of the prototype blueprint. The prototype blueprint may be syntactically analyzed by checking a configuration of the prototype blueprint against at least one rule in a markup language used to write the configuration to ensure that the configuration of the prototype blueprint has correct syntax. The configuration may be checked by screening the configuration for correct use of the markup language.

At operation 312, the prototype blueprint may be modified to remove the at least one syntactic error to obtain a syntactically correct prototype blueprint, in a first instance of the syntactically analyzing where at least one syntactic error is identified. The prototype blueprint may be modified by adding, removing, and/or changing at least one character in the at least one syntactic error.

At operation 314, the prototype blueprint may be concluded to be the syntactically correct prototype blueprint, in a second instance of the syntactically analyzing where no syntactic errors are identified. The prototype blueprint may be concluded to be the syntactically correct prototype blueprint by determining that the prototype blueprint does not include the at least one syntactic error.

Turning to FIG. 3C, at operation 316, an interrupt-driven syntactically correct blueprint may be obtained, using the syntactically correct prototype blueprint, prior to identifying the occurrence of the blueprint use event and after syntactically analyzing the prototype blueprint, by adding the checkpoints in the interrupt-driven syntactically correct blueprint to track operation of the data processing system. The interrupt-driven syntactically correct blueprint may be obtained by adding at least one check of the checkpoints to a configuration of the syntactically correct prototype blueprint, from a description of operation 312 of FIG. 3B.

At operation 318, monitoring of the sandboxed operation may be performed, using the interrupt-driven syntactically correct blueprint, for an inefficient performance of the data processing system. The monitoring of the sandboxed operation may be performed by recording at least one metric of the sandboxed operation that uses the configuration of the interrupt-driven syntactically correct blueprint. The at least one metric may demonstrate an inefficient performance of the sandboxed operation.

At operation 320, the interrupt-driven syntactically correct blueprint may be modified to improve the inefficient performance of the interrupt-driven syntactically correct blueprint to obtain an optimized interrupt-driven syntactically correct blueprint, in the first instance of the monitoring where at least one metric, from the sandboxed operation, is obtained that indicates the inefficient performance. The interrupt-driven syntactically correct blueprint may be modified by performing at least one modification in a configuration of the interrupt-driven syntactically correct blueprint. The at least one modification may include (i) adjusting CPU, memory, and/or storage resource limits, (ii) implement and/or refine indexing strategies to increase a rate of query performance, (iii) refactor the unoptimized code to generate more efficient algorithms of the configuration, (iv) introduce load balancing mechanisms to scale loads, etc.

At operation 322, the interrupt-driven syntactically correct blueprint may be concluded to be the optimized interrupt-driven syntactically correct blueprint, in the second instance of the monitoring where the metric, from the sandboxed operation, is obtained that does not indicate the inefficient performance of the data processing system. The interrupt-driven syntactically correct blueprint may be concluded to be the optimized interrupt-driven syntactically correct blueprint by determining that none of the at least one metric indicates the inefficient performance in the sandboxed operation.

Turning to FIG. 3D, at operation 324, an anomalous behavior analysis may be performed using the optimized interrupt-driven syntactically correct blueprint, prior to identifying the occurrence of the blueprint use event and after monitoring of the sandboxed operation for the inefficient performance of the data processing system, of the sandboxed operation of the data processing system. The anomalous behavior analysis may be performed by (i) simulating, using the optimized interrupt-driven syntactically correct blueprint, the operation of the data processing system and (ii) screening the simulating of the operation of the data processing system using at least one machine learning method for at least one anomalous behavior, the anomalous behavior being an unexpected behavior or at least one deviation from an expected behavior.

The operation of the data processing system may be simulated by continuing the sandboxed operation of the configuration of the optimized interrupt-driven syntactically correct blueprint, from the description of operation 322 in FIG. 3C. The simulating of the operation of the data processing system may be screened by ingesting, by the at least one machine learning method, at least one metric obtained from the simulating of the operation.

At operation 326, the optimized interrupt-driven syntactically correct blueprint may be modified to remove the at least one anomalous behavior of the optimized interrupt-driven syntactically correct blueprint to obtain an anomaly-free optimized interrupt-driven syntactically correct blueprint, in the first instance of the performing where at least one anomalous behavior has been found in the sandboxed operation. The optimized interrupt-driven syntactically correct blueprint may be modified by performing at least one modification the configuration of the optimized interrupt-driven syntactically correct blueprint. The at least one modification may include (i) adjusting parameter values (e.g., establishing desired memory allocation limits, desired thread limits, desired log retention timelines, etc.), (ii) including new security protocols (e.g., opening and closing ports, setting encryption parameters, establishing authentication mechanisms), (iii) defining new policies that regulate data processing for different types of data, etc.

At operation 328, the optimized interrupt-driven syntactically correct blueprint may be concluded to be the anomaly-free optimized interrupt-driven syntactically correct blueprint, in the second instance of the performing where at least one anomalous behavior has not been found in the operation. The optimized interrupt-driven syntactically correct blueprint may be concluded to be the anomaly-free optimized interrupt-driven syntactically correct blueprint by determining that the simulating of the operation of the data processing system does not include an anomalous behavior.

At operation 330, the anomaly-free optimized interrupt-driven syntactically correct blueprint may be secured using at least one authentication method to obtain the blueprint. The anomaly-free optimized interrupt-driven syntactically correct blueprint may be secured by (i) tracking at least one change to the blueprint and (ii) permitting reverting of the at least one change to the blueprint. The at least one change may be tracked by recording, using a log, the at least one change that is made to the blueprint. The reverting of the at least one change may be permitted by removing, by a request made by an authorized user, the at least one change on the blueprint to obtain the blueprint without the at least one change.

Thus, via the method shown in FIG. 3B-3D, embodiments herein may likely improve a likelihood of managing the operation of the deployment. By improving the likelihood of managing the operation of the deployment, the data processing systems may be more likely to provide desirable computer implemented services by, for example, hardening the configuration of the blueprint using validation steps, at least one controlled environment to test for inefficient performance and/or at least one anomalous behavior, securing the blueprint to track at least one change to the blueprint, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
identifying an occurrence of a blueprint use event with respect to a data processing system of the deployment;
based on the occurrence of the blueprint use event:
obtaining a blueprint, the blueprint being a validated blueprint based on both syntactic analysis and sandboxed operation, and the blueprint comprising checkpoints usable to improve a likelihood of successful updating of the data processing system using the blueprint and control data to limit use of the blueprint;
updating the data processing system using the blueprint to obtain an updated data processing system; and
providing computer implemented services using at least the updated data processing system.

2. The method of claim 1, wherein obtaining the blueprint comprises:
receiving, from an administrator or a repository of blueprints and based on the blueprint use event, the blueprint.

3. The method of claim 1, wherein updating the data processing system using the blueprint comprises:
performing, using the blueprint, at least one update to place the data processing system in a verified operating state while the computer implemented services are provided.

4. The method of claim 1, further comprising:
prior to identifying the occurrence of the blueprint use event:
obtaining a prototype blueprint for use with data processing systems of the deployment;
syntactically analyzing the prototype blueprint to identify syntactic errors in markup language of the prototype blueprint;
in a first instance of the syntactically analyzing where at least one syntactic error is identified:
modifying the prototype blueprint to remove the at least one syntactic error to obtain a syntactically correct prototype blueprint; and
in a second instance of the syntactically analyzing where no syntactic errors are identified:
concluding that the prototype blueprint is the syntactically correct prototype blueprint.

5. The method of claim 4, wherein syntactically analyzing the prototype blueprint to identify the syntactic errors comprises:
checking a configuration of the prototype blueprint against at least one rule in a markup language used to write the configuration to ensure that the configuration of the prototype blueprint has correct syntax.

6. The method of claim 4, further comprising:
prior to identifying the occurrence of the blueprint use event and after syntactically analyzing the prototype blueprint:
obtaining, using the syntactically correct prototype blueprint, an interrupt-driven syntactically correct blueprint by adding the checkpoints in the interrupt-driven syntactically correct blueprint to track operation of the data processing system;
performing, using the interrupt-driven syntactically correct blueprint, monitoring of the sandboxed operation for an inefficient performance of the data processing system;
in the first instance of the monitoring where a metric, from the sandboxed operation, is obtained that indicates the inefficient performance of the data processing system:
modifying the interrupt-driven syntactically correct blueprint to improve the inefficient performance of the interrupt-driven syntactically correct blueprint to obtain an optimized interrupt-driven syntactically correct blueprint; and
in the second instance of the monitoring where the metric, from the sandboxed operation, is obtained that does not indicate the inefficient performance of the data processing system:
concluding that the interrupt-driven syntactically correct blueprint is the optimized interrupt-driven syntactically correct blueprint.

7. The method of claim 6, wherein performing the monitoring of the sandboxed operation comprises:
simulating, using the interrupt-driven syntactically correct blueprint, the operation of the data processing system in an isolated environment apart of the deployment; and
obtaining, based on the simulating of the operation of the data processing system, the metric that indicates the inefficient performance of the data processing system.

8. The method of claim 6, further comprising:
prior to identifying the occurrence of the blueprint use event and after monitoring of the sandboxed operation for the inefficient performance of the data processing system:
performing, using the optimized interrupt-driven syntactically correct blueprint, an anomalous behavior analysis of the sandboxed operation of the data processing system;
in the first instance of the performing where at least one anomalous behavior has been found in the sandboxed operation:
modifying the optimized interrupt-driven syntactically correct blueprint to remove the at least one anomalous behavior of the optimized interrupt-driven syntactically correct blueprint to obtain an anomaly-free optimized interrupt-driven syntactically correct blueprint;
in the second instance of the performing where at least one anomalous behavior has not been found in the operation:
concluding that the optimized interrupt-driven syntactically correct blueprint is the anomaly-free optimized interrupt-driven syntactically correct blueprint;
securing the anomaly-free optimized interrupt-driven syntactically correct blueprint using at least one authentication method to obtain the blueprint.

9. The method of claim 8, wherein performing the anomalous behavior analysis comprises:
simulating, using the optimized interrupt-driven syntactically correct blueprint, the operation of the data processing system; and
screening the simulating of the operation of the data processing system using at least one machine learning method for at least one anomalous behavior, the anomalous behavior being an unexpected behavior or at least one deviation from an expected behavior.

10. The method of claim 8, wherein the at least one authentication method is used protect the blueprint from unauthorized use by assigning an authorized user of the blueprint at least a private key for encryption of the blueprint and at least a public key for decryption of the blueprint.

11. The method of claim 8, wherein securing the anomaly-free optimized interrupt-driven syntactically correct blueprint using the at least one authentication method comprises:
tracking at least one change to the blueprint; and
permitting reverting of the at least one change to the blueprint.

12. A non-transitory machine-readable medium having instructions stored therein, which when executed by a processor, cause the processor to perform operations for managing operation of a deployment, the operations comprising:
identifying an occurrence of a blueprint use event with respect to a data processing system of the deployment;
based on the occurrence of the blueprint use event:
obtaining a blueprint, the blueprint being a validated blueprint based on both syntactic analysis and sandboxed operation, and the blueprint comprising checkpoints usable to improve a likelihood of successful updating of the data processing system using the blueprint and control data to limit use of the blueprint;
updating the data processing system using the blueprint to obtain an updated data processing system; and
providing computer implemented services using at least the updated data processing system.

13. The non-transitory machine-readable medium of claim 12, wherein obtaining the blueprint comprises:
receiving, from an administrator or a repository of blueprints and based on the blueprint use event, the blueprint.

14. The non-transitory machine-readable medium of claim 12, wherein updating the data processing system using the blueprint comprises:
performing, using the blueprint, at least one update to place the data processing system in a verified operating state while the computer implemented services are provided.

15. The non-transitory machine-readable medium of claim 12, wherein the operations further comprise:
prior to identifying the occurrence of the blueprint use event:
obtaining a prototype blueprint for use with data processing systems of the deployment;
syntactically analyzing the prototype blueprint to identify syntactic errors in markup language of the prototype blueprint;
in a first instance of the syntactically analyzing where at least one syntactic error is identified:
modifying the prototype blueprint to remove the at least one syntactic error to obtain a syntactically correct prototype blueprint; and
in a second instance of the syntactically analyzing where no syntactic errors are identified:
concluding that the prototype blueprint is the syntactically correct prototype blueprint.

16. The non-transitory machine-readable medium of claim 15, wherein syntactically analyzing the prototype blueprint to identify the syntactic errors comprises:
checking a configuration of the prototype blueprint against at least one rule in a markup language used to write the configuration to ensure that the configuration of the prototype blueprint has correct syntax.

17. A system, comprising:
a processor; and
a memory coupled to the processor to store instructions, which when executed by the processor, cause the processor to perform operations managing operation of a deployment, the operations comprising:
identifying an occurrence of a blueprint use event with respect to a data processing system of the deployment;
based on the occurrence of the blueprint use event:
obtaining a blueprint, the blueprint being a validated blueprint based on both syntactic analysis and sandboxed operation, and the blueprint comprising checkpoints usable to improve a likelihood of successful updating of the data processing system using the blueprint and control data to limit use of the blueprint;
updating the data processing system using the blueprint to obtain an updated data processing system; and
providing computer implemented services using at least the updated data processing system.

18. The system of claim 17, wherein obtaining the blueprint comprises:
receiving, from an administrator or a repository of blueprints and based on the blueprint use event, the blueprint.

19. The system of claim 17, wherein updating the data processing system using the blueprint comprises:
performing, using the blueprint, at least one update to place the data processing system in a verified operating state while the computer implemented services are provided.

20. The system of claim 17, wherein the operations further comprise:
prior to identifying the occurrence of the blueprint use event:
obtaining a prototype blueprint for use with data processing systems of the deployment;
syntactically analyzing the prototype blueprint to identify syntactic errors in markup language of the prototype blueprint;
in a first instance of the syntactically analyzing where at least one syntactic error is identified:
modifying the prototype blueprint to remove the at least one syntactic error to obtain a syntactically correct prototype blueprint; and
in a second instance of the syntactically analyzing where no syntactic errors are identified:
concluding that the prototype blueprint is the syntactically correct prototype blueprint.
